(19) United States
(12) Patent Application Publication
(10) Pub. No.: US 2005/0181107 A1
(43) Pub. Date: Aug. 18, 2005

(54) Coffee extracts, their use as flavoring ingredients and as instant coffee type products

(76) Inventors: Ferdinand Naef, Carouge (CH); Eric Frerot, Ville La Grand (FR); Pierre-Etienne Bouquerand, Pers-Jussy (FR); Daniel Benczedi, Plan-Les-Ouates (CH)

Correspondence Address: WINSTON & STRAWN LLP, 1700 K STREET, N.W., WASHINGTON, DC, 20006, US

(21) Appl. No.: 11/101,054

(22) Filed: Apr. 6, 2005

Related U.S. Application Data
(63) Continuation of application No. PCT/IB03/04381, filed on Oct. 2, 2003.

(30) Foreign Application Priority Data
Oct. 11, 2002 (WO) PCT/IB02/04199

(51) Int. Cl. A23F 5/00

(52) U.S. Cl. 426/594

(57) ABSTRACT

A solid coffee product susceptible of being obtained via a process that includes the following steps: a) the extraction with water, at a temperature below 70° C., of ground coffee obtained from green coffee beans; b) the removal of the water from the thus obtained aqueous extract to form a solid extract of green coffee; and c) the thermal treatment of the solid extract of green coffee at an appropriate temperature and for an amount of time sufficient to obtain a solid coffee product.

### CROSS-REFERENCE TO RELATED APPLICATIONS

This application is a continuation of International application PCT/IB2003/004381 filed Oct. 2, 2003, the entire content of which is expressly incorporated herein by reference thereto.

### BACKGROUND OF THE INVENTION

The present invention relates to the flavor and coffee industries. It concerns more particularly the preparation of coffee extracts useful for flavoring consumer products, namely coffee based beverages, and for producing instant coffee beverages.

The literature is rich in reports relating to processes for extracting coffee of a great variety of origins, namely to analyze the components thereof. However, in spite of this, to our knowledge it has never been suggested to use a coffee extract obtained from water extraction of green coffee beans as a flavoring ingredient or composition, or as an instant coffee product. This is probably the result of the fact that the extraction products described in the prior art heretofore are generally conceived to achieve as an objective the selective extraction of certain precursors of the green coffee aroma, the nature or concentration of which it is desired to know, or to study the reaction evolution occurring during coffee roasting. As a result, either such processes are not appropriate to provide coffee extracts with useful organoleptic properties, since they contain only a limited number of the aromatic precursors which play a predominant role in the taste of roasted coffee, or, assuming that such extracts were ever obtained, their organoleptic properties and their potential value for a flavoring use went totally unnoticed.

Thus, a study reported by C. A. B. De Maria et al. in Food Chem. 50, 141 (1994), described the analysis of water soluble fractions of a Arabica type green coffee. In spite of the fact that these authors took ground green coffee, prior defatted with organic solvents, and subjected it to extraction with water at a temperature of 80° C., there is strictly no description in this document of any potentially useful organoleptic properties of this extract, nor any suggestion of its possible use as a flavoring ingredient for the preparation of flavoring compositions or of flavored products, namely soluble coffee products. In fact, in their evident concern to exhaustively extract all the water soluble constituents of green coffee, these authors used extraction and thermal treatment conditions which were inappropriate for the production of an extract whose organoleptic properties are convenient to flavor consumer products.

On the other hand, it should also be noted that, up until now, when it was desired to impart to beverages or foods the taste and aromatic characteristics of coffee drink, the current practice has been to add thereto mixtures of volatile flavor ingredients, typically components of roasted coffee, allowing a more or less adequate reconstitution of the taste and flavor of coffee. To our knowledge it has never been suggested to directly use an aqueous extract of green coffee as a flavoring composition.

The present invention brings precisely a novel contribution to the flavoring of coffee based consumer products, by providing novel flavoring ingredients, capable of being used as “building-blocks” for the preparation of flavoring compositions having a variety of aromatic notes, in some cases perfectly typical of coffee taste, and in others also useful to impart cereal, caramel and sugar type notes.

Another object of the invention is to provide an improved method for creating novel instant coffee products based on the invention's green coffee extracts.

Typically, instant or soluble coffee is the dried portion of an aqueous extract of roasted coffee, which can present itself in either granular or powder form, for immediate make-up in hot water. However, this dried coffee extract is typically prepared via a method (see for example, Encyclopedia of Food Science, Food Technology and Nutrition, pages Coffee 1128 to 1131, ed. R. Macrae et al., Academic Press, USA, 1993) according to which green coffee beans are subjected to roasting and drying conditions which provoke evaporation of a considerable amount of the volatile components of green coffee responsible for the coffee taste. The ground roasted coffee is then typically extracted with an aqueous liquid, the extract being filtered and then concentrated by evaporation, which results in a further loss of volatiles. Finally, during storage and use of instant coffee containers, the volatiles contained in the coffee powder or granules are gradually lost by evaporation and are very sensitive to oxidation and moisture.

Thus, in order to improve the taste quality of instant coffee products, it has been suggested in U.S. Pat. No. 5,399,368, to Garwood et al., a method of encapsulating volatile aroma compounds and in particular coffee oil, so as to allow storage for long periods of time of both the aroma compounds and the consumer products, namely soluble coffee, containing them. This disclosure however does not in any way improve the method of producing instant coffee, it simply provides an improved method for preparing flavors to be added to the soluble coffee to compensate for the loss of volatiles which occurs during the preparation of the dried coffee granules or powders. In other words, the products obtained by this prior art process are simply used to try and reconstitute the taste of beverages prepared using roasted coffee beans. In fact, the solid aroma product thus obtained is simply added to the soluble coffee powder or granules and released when hot water is added thereto.

### SUMMARY OF THE INVENTION

The invention relates to a solid coffee product susceptible of being obtained via a process comprising the following steps:
a) the extraction with water, at a temperature below 70° C., of ground coffee obtained from green coffee beans;
b) the removal of the water from the thus obtained aqueous extract to form a solid extract of green coffee; and
c) the thermal treatment of said solid extract of green coffee at an appropriate temperature and for an amount of time sufficient to obtain a solid coffee product.

The invention also concerns instant coffee prepared from such a solid coffee product, as well as flavor compositions and flavored products comprising the above cited coffee product, optionally admixed with a variety of other ingredients useful for the aromatisation of foods, beverages, chewing gums, oral care products, pharmaceutical preparations and the like.

The invention makes it possible to prepare an instant or soluble coffee product with improved organoleptic properties, by directly subjecting a green coffee extract obtained according to the invention and as described above, to a thermal treatment, an example of which is an extrusion process which retains in an optimal manner the volatile constituents of said extract and makes it possible to prepare coffee powder or granules readily soluble in water. The product thus obtained is directly usable to prepare coffee by addition thereto of hot water and retains a far higher amount of the coffee components that ensure a good coffee taste, similar to the taste of freshly brewed coffee. In fact, the extruded coffee product thus obtained retains the components of the extract in a glassy polymeric matrix which preserves the taste integrity of the extract and dispenses with the addition of flavor ingredients to reconstitute the desired coffee taste.

### BRIEF DESCRIPTION OF THE DRAWING FIGURE

FIG. 1 is a graphic representation of the temperature variation and the duration of the roasting of green coffee extract according to one embodiment of the invention.

### DETAILED DESCRIPTION OF THE PREFERRED EMBODIMENTS

An object of the invention is an extract of green coffee susceptible of being obtained by a process comprising the following steps:
a) the extraction with water, at a temperature below 70° C., of coffee obtained by grinding green coffee beans; and
b) the removal of the water from the thus obtained aqueous extract to form a solid extract of green coffee.

We have in fact established that the coffee extracts obtained in this manner, once roasted, possessed very useful organoleptic properties and can in particular be used to impart a taste characteristic of freshly brewed coffee, very natural and rich in roast and caramel notes. The extracts thus obtained proved to be particularly useful to flavor coffee-based beverages, namely soluble coffee of commercial origin.

We have further established that the taste and aroma quality, i.e. the organoleptic properties of these coffee extracts according to the invention, could be controlled via the conditions of their preparation. For example, in addition to the temperature at which the extraction with water was carried out, the amount of water used and the duration of the extraction also proved to be parameters that could play a more or less important role in the organoleptic properties of the extract. Thus, extracts obtained at relatively low extraction temperatures, namely between 3 and 40° C., and preferably between 15 and 25° C., provided very good extracts according to the invention, which developed, after roasting, odors reminiscent of the aroma of freshly brewed coffee and which possessed a taste rich in notes of the roasted and slightly sweet coffee type, also caramel-like, very rounded and practically devoid of the phenolic and bitter notes which seem to characterise the extracts obtained at water extraction temperatures above 70° C.

On the other hand, it became apparent in practice that the volume of water used in the extraction and the duration of the latter, although apparently playing a less determinant role than the temperature of extraction, could influence considerably the quality of the product, depending on the extraction method used. According to a more convenient embodiment of the invention, the step of extraction with water is carried out via a method which consists in stirring for at least 2 hours a suspension of ground green coffee in water and then filtering the resulting solution to collect the filtrate.

The stirring of the suspension is carried out with a conventional type stirrer, at a turning speed that allows good homogenization of the mixture. It goes without saying that the extraction can last for much longer time periods. We observed that, following this process, extraction times of 2 h or more provided extracts with the desired organoleptic properties. Moreover, our experiments showed that stirring times of up to 25 hours could be used, durations of 3 to 5 hours having however proved to be ideal, allowing the production of extracts of excellent quality in a time period appropriate for industrial production.

The volumes of water that can be used in this extraction vary in a wide range of values, typically from 3 to 40 ml, or even more, per gram of ground coffee. We have established for example that excellent green coffee extracts could be obtained with this method by using 3 to 20 ml of water, per gram of ground coffee.

The temperature of the water and its amount, in the extraction step, can of course both be easily adjusted interdependently, preferably maintaining each of these parameters within the respective limits mentioned above. Specific examples of the extraction conditions are disclosed further on. A particularly advantageous realization of this step consists in effecting the extraction at about 20° C., using a water volume comprised between 3 and 10 ml per gram of ground coffee, and extracting for 5 h.

The filtered solution obtained after extraction is then converted into a solid residue by removing the water, typically by spray-drying or freeze-drying.

Alternatively, the extraction of green coffee may be effected by repeated percolation of the ground coffee. Higher water volumes than those cited above will then be typically used and the repeated extractions will generally be realized in shorter times. The various filtrates thus obtained are then combined and dried in the same manner as with the extracts obtained by suspending the ground coffee in water.

We observed that the extracts of green coffee of the invention were characterized by a content in chlorogenic acid that does not exceed 15% by weight, relative to the weight of the extract. This value proved to be lower than that of the extracts obtained following De Maria et al.'s teachings in the reference cited earlier on.

The solid extract of green coffee obtained in the above-described manner then undergoes a thermal treatment intended to provide it with the typical roast characteristics of coffee. This thermal treatment is carried out at a temperature, and for a period of time, sufficient to obtain adequate solid coffee products.

The values of these two parameters that can be used in an embodiment according to the invention wherein there is obtained a roasted coffee product, vary in a wide range of values, current in the art of coffee roasting. They vary in an inverse proportion, i.e. the shorter the time of roasting, the higher the temperature, and vice-versa. By way of example, temperatures comprised between 170 and 250° C. can be used, for a roasting time varying from 2-3 minutes up to 20 or even 30 minutes. Roasted extracts according to the invention are thus obtained.

An advantageous manner of operation of this embodiment of the process of the invention is that wherein the extract of green coffee obtained in the first step undergoes a thermal treatment at a temperature comprised between 180 and 220° C., for a period of time of 3 to 20 minutes, varying inversely to the temperature. We established moreover that the roasted coffee extracts obtained according to the invention, by heating at about 190° C. for approximately 10 minutes, proved to be excellent flavoring ingredients that, when dissolved in boiling water, reproduced the typical odor notes of freshy prepared coffee and presented a taste typical of the best quality roasted coffee, without excessive bitterness and characterized by very round coffee notes.

Specific examples of other possible roasting conditions according to this embodiment of the invention are presented further on.

Such examples clearly show that the coffee extracts of the invention, obtained by the process described above and which is also an object of the latter, possess organoleptic qualities far superior to those of the prior art coffee extracts that can be obtained by the process described by De Maria et al.

According to this particular embodiment of the invention, the extract of green coffee obtained as described previously can be admixed before roasting with one or several sugars selected from the group consisting of sucrose, glucose, fructose and arabinose. The compositions thus obtained, e.g. those containing sucrose, proved to be very advantageous flavoring materials, possessing the typical taste of coffee and an enhanced roasted, grilled note, relative to that of the coffee extract used to prepare them, when the latter was roasted under similar conditions.

We have also established that the organoleptic properties of the coffee products of the invention could be remarkably improved by adding to the extract of green coffee, obtained after the extraction step, one or more amino acids selected from the group consisting of arginine, cysteine, leucine, isoleucine, serine, threonine, thiamine, lysine, histidine and their edible salts, namely their hydrochlorides. Once roasted, these compositions of the invention provided particularly valued flavoring ingredients.

Preferred mixtures contained several sugars and amino acids, amongst those above cited.

According to another embodiment of the process of the invention, the thermal treatment of the solid and dried extract of green coffee obtained as described before can consist in the preparation of a melt of said extract together with oligosaccharides, such as maltodextrins, modified starches, coffee carbohydrates, capable of forming a glassy solid when extruded.

The invention thus also provides a process for the preparation of a solid coffee product, wherein the dried extract of green coffee, obtained as described before, is admixed with a carbohydrate matrix material and an appropriate amount of a plasticizer, and the mixture is then heated within a screw extruder to a temperature above the glass transition temperature of the matrix material so as to form a molten mass capable of being extruded through a die.

The extrusion process can be carried out as described in the prior art, namely in documents such as patent application WO 00/25606, published May 11, 2002 or WO 01/17372, published Mar. 15, 2001, and the documents cited therein, the contents of which are hereby included by reference.

Extrusion is a widely used process for encapsulating active ingredients known to be volatile and labile. The flavor industry in particular is well fitted with a rich literature, notably patents, related to extrusion processes used for the preparation of encapsulated flavouring ingredients or compositions. However, to our knowledge there has never been any description or suggestion of the preparation of a solid coffee product via extrusion of a melt comprising an extract of green coffee such as described above.

We have now established that the glassy coffee products obtained by extrusion according to the present invention, possess excellent organoleptic properties which render them particularly suitable for directly preparing coffee by dissolving them in boiling water.

The understanding of the glassy state and its importance in food products has been considerably extended in recent years. Several methods of creating glass-like states can be used and have been reported in the literature. The concept of glass transition temperature (Tg) is well described in the literature. It represents the transition temperature from a rubbery liquid state to a glassy solid state; such a transition is characterised by a rapid increase in viscosity over several orders of magnitude and over a rather small temperature range. It is recognised by many experts in the field that, in the glassy state, i.e. at temperatures below Tg, all molecular translation is halted and it is this process which provides such effective entrapping of the volatile flavours and prevention of other chemical events such as oxidation.

Implicit in much of the literature is the converse, namely that at temperatures above Tg, the encapsulation of flavors or other active materials will be ineffective and hence the importance of creating solid capsules by formulating polymeric matrices with Tg values above ambient temperature.

The physical state of an encapsulating matrix can thus be expressed by the difference (T-Tg), T being the temperature surrounding the system, i.e. the extrusion temperature when reference is made to the encapsulation process, and the ambient or storage temperature, namely a temperature typically comprised between 20 and 25° C. when reference is made to the storage of the final product, after the end of the extrusion process.

When T is equal to Tg, the surrounding temperature corresponds to the glass transition temperature of the system; when (T-Tg) is negative, the system is in the glassy state and the more the difference is negative, the more viscous is the system. Conversely, in the rubbery state, i.e. when (T-Tg) is positive, the more positive is the difference, the less viscous is the system.

The glass transition temperature of a matrix can usually be adapted as desired by combining a thermoplastic polymer of appropriate molecular weight with a solvent able to lower the viscosity and thus the Tg of the neat polymer by plasticization. As an example, water can be used to plasticize the more hydrophilic polymers whereas less polar solvents are used to plasticize more hydrophobic polymers.

The difference (T-Tg) evolves during the different steps of an extrusion process and is representative of the changes in the physical state of the system.

Thus, according to this latter embodiment of the invention, the extract of green coffee is admixed with an appropriate carbohydrate matrix which is maintained in a plasticized liquid state by properly selecting the processing temperature and the plasticizer concentration to fulfill the requirements for a positive difference (T-Tg).

Typically the plasticizer concentration is such that the difference (T-Tg) is positive and greater than 100° C. to maintain the extract phase dispersed homogeneously in the carbohydrate melt as it is extruded through the die. Such an extrusion process however requires a drying step, because the product exiting the die possesses a Tg which is too low (product in a liquid state) to produce a solid once the product has been cooled to storage temperature. This drying step thus allows the final Tg of the extruded product to be raised to a value above the ambient or room temperature, i.e. above a temperature typically comprised between 10 and 30° C., such that T-Tg is negative and the extruded product is a free flowing solid.

The extruded coffee products according to the invention can thus be prepared following any of the known screw extruder methods described in the prior art, such as for example in WO 00/25606, namely pages 10 to 18 and examples 7 to 14, the contents of which are hereby included by reference. Following an advantageous method however, the amount of plasticizer used is low and the extrusion temperature is comprised between 90 and 130° C., so as to form a melt which provides a product exiting the die in a plastic state sufficiently viscous to be directly cut as it exits. Such a method is described in detail in WO 01/17372, the contents of which are hereby included by reference.

By a low content in plasticizer we mean here a content in plasticizer which ensures that the glass transition temperature of the mixture of carrier and extract of green coffee is substantially the same as the glass transition temperature of the final extruded coffee product and is above room temperature, preferably above 40° C.

Such a process thus dispenses with the use of a final drying or dehydrating step and therefore makes it possible to better preserve the quality of the extract of green coffee with regard to the volatiles there-contained.

The pressure during the extrusion step is typically maintained below 100×10⁵ Pa, and preferably comprised between 1 and 50×10⁵ Pa.

In practising this embodiment of the invention, the dried green coffee extract component is firstly dispersed by mechanical agitation in a homogeneous solution of a matrix or carrier material.

As the matrix, there can be used any carbohydrate or carbohydrate derivative which can be readily processed through extrusion techniques to form a dry extruded solid. Particular examples of suitable materials include those selected from the group consisting of sucrose, glucose, lactose, maltose, fructose, ribose, dextrose, isomalt, sorbitol, mannitol, xylitol, lactitol, maltitol, pentatol, arabinose, pentose, xylose, galactose, Trehalose ®, hydrogenated corn syrup, maltodextrin, modified starches, agar, carrageenan, gums, polydextrose and derivatives and mixtures thereof. Other suitable carrier ingredients are cited in reference texts such as H. Scherz, Hydrokolloide: Stabilisatoren, Dickungsund Geliermittel in Lebensmittel, Band 2 der Schriftenreihe Lebensmittelchemie, Lebensmittelqualität, Behr's VerlagGmbH & Co, Hamburg, 1996. According to the invention there will be preferably used a maltodextrin having a dextrose equivalent not above twenty (≦20 DE).

The above-mentioned matrix materials are hereby given by way of example and they are not to be interpreted as limiting the invention. Although polysaccharides are mentioned above as specific examples, it is clear that any material which is extrudable and currently used as a matrix material in the production of extruded solids is adequate for the aim of the invention and is therefore hereby included in the latter.

Particularly advantageous matrix materials in the context of the present invention are coffee carbohydrates capable of forming a coffee glass. Examples of such coffee carbohydrates, and of the manner in which they can be extruded together with the active material to be encapsulated, are disclosed in U.S. Pat. No. 5,399,368, columns 3 to 10 in particular. Although this prior art document deals with the encapsulation of flavor materials, its teachings relating to the nature of the coffee carbohydrates that can be used in extrusion processes and to the method of extruding a mixture of said carbohydrates with an active encapsulate material, are pertinent to the instant disclosure and are hereby included by reference.

We have in fact been able to established that such coffee carbohydrates as those described in U.S. Pat. No. 5,399,368 can be efficiently admixed with the extracts of green coffee obtained as here described and extruded by a similar method to that taught in U.S. Pat. No. 5,399,368 to provide a solid coffee extrudate which, when added of boiling water, provides an instant coffee beverage of far improved taste over that of the soluble coffees to which there are added extruded flavors based on coffee oil or coffee flavoring compositions which do not contain said extract of green coffee. Moreover, we have also established that the green coffee extract, obtained as described above, can be used as such, i.e. without any adjuvants other than the plasticizers, as the extrusion raw material, thus dispensing the use of maltodextrine or other carbohydrate materials not present in the extract of green coffee.

An emulsifier agent is preferably added to the mixture constituted by the matrix component and the extract of green coffe. Typical examples include lecithin and citric acid esters of fatty acids, but other suitable emulsifiers are cited in reference texts such as Food Emulsifiers and their Applications, 1997, edited by G. L. Hasenhuettl and R. W. Hartel.

The glass transition temperature of the extract/carbohydrate mixture depends on the amount of water added to the initial mixture. In fact, it is well known in the art that the Tg decreases when the proportion of water increases. In the present invention, the proportion of water added to the mixture will preferably be low, i.e. such that the glass transition temperature of the resulting mixture is substantially equal to the glass transition temperature desired for the final extruded coffee product.

However, as mentioned above, a requirement for the resulting encapsulated compound or composition is to present a glass transition temperature Tg significantly above the temperature at which it will be stored and subsequently used. The critical temperature must thus be at least above room temperature and preferably above 40° C. The proportions in which water or another plasticizer is employed in the present invention therefore vary in a wide range of values which the skilled person is capable of adapting and choosing as a function of the carbohydrate glass used in the matrix and the required Tg of the final extruded coffee product.

For instance, for a carbohydrate glass having a DE of (dextrose equivalent) of 18, proportions from 5 to 10% of water in the mixture can be used.

The softening or glass transition temperature is preferably kept above 40° C. to guarantee the free flowing nature of the produced powder samples at ambient temperature. A low water content, to guarantee that the carrier's glass transition temperature is above room temperature and preferably above 40° C., is thus added to the mixture.

The extruding step requires an extruding apparatus. A commercially acceptable extruding apparatus is that under the trade name designation Clextral BC 21 twin-screw extruder equipped with a cutterknife allowing to chop the melt at the die exit, when it is still in a plastic condition. However, extruding apparatuses are not limited to the twin screw variety and may also include, for example, single screw, ram, or other similar extrusion methods. The mentioned extruding apparatuses allow to extrude at pressure which are sufficiently high to provide a molten mass, possibly in a plastic condition.

The extrusion apparatus is equipped with a temperature regulation mechanism which maintains the temperature of the mixture at a temperature above the glass transition temperature of the carrier, set to a value comprised between 90 and 130° C. through the entire extrusion process.

During the extrusion process, the mixture is forced through a die having an orifice with a predetermined diameter which ranges from about 0.250 to 10 mm and preferably from 0.7 to 2.0 mm. However, much higher diameters for the die are also possible.

According to this preferred embodiment of the invention in which the molten mass is cut as it exits the die, the die orifice is at the same temperature as that of the rest of the apparatus, and is equipped with a cutterknife or any other cutting device allowing to chop the melt as it exits from the die, when it is still plastic. The product which is cut is thus still at a temperature which is above the glass transition temperature of the matrix. The length of the pieces is regulated by controlling the stroke rate of the specific cutting apparatus. The severed pieces are subsequently cooled to ambient temperature by the surrounding air. No drying or further treatment is needed. The resulting granules present a size uniformity.

The invention thus provides roasted or extruded coffee extracts and mixtures containing them, that can be used on their own to aromatize foods and beverages, or that can be used as building-blocks for the preparation of more complex flavoring compositions which are then added to said edible products, e.g. foods and beverages, as such, in the form of solutions in the solvents usually employed in such consumer products or yet supported on solid carriers of current use.

Therefore, the coffee products and the compositions mentioned above according to the invention are particularly useful to impart or modify the typical coffee taste and flavor qualities of the flavoring compositions, foods and beverages in which they are incorporated. They can in particular be used to improve the taste of soluble coffees of commercial origin or of similar products, e.g. the coffee based drinks which are popular in countries such as Japan. The flavoring products of the invention can also be used to impart a coffee taste to a variety of edible consumer products such as ice creams or frozen desserts, puddings, confectioneries, flans, yoghurts, varied biscuits and creams therefor, chewing gums, or in general any product can be suitably flavored with a coffee taste.

More particularly, the coffee products according to the invention can be used as building-blocks of coffee flavors, in which they can be typically mixed with volatile ingredients of current use in the flavors of this type, as well as with the solvents and adjuvants normally used.

It is of course impossible to name here all the other ingredients typically used in the creation of flavors and which can be admixed with the coffe products of the invention, to prepare in particular coffee type flavors, the properties of which can be enhanced via the use of the coffee products according to the invention. Such ingredients are well known to the flavorist, who is well able to select them as a function of the specific flavoring effect he wants to achieve and of the nature of the food, beverage or other product to be flavored.

The concentrations in which they are typically used to this effect vary in a wide range of values. The latter are a function of the nature of the product to be flavored and of the intensity and quality of the taste that is desired to be imparted to said product. They further depend on the other flavoring ingredients possibly present in any flavoring composition prepared on the basis of the coffee products of the invention. By way of example, there can be cited concentration values comprised within a range varying from 0.01 up to 50% by weight, or even more, and more particularly comprised between 0.01 and 10% by weight, relative to the weight of the flavoring composition or of the product to which the roasted or extruded coffee extract is added.

A particularly interesting application is in fact the use of the coffee products of the invention in powder or granular form as a soluble coffee. As already cited above, we have in fact been able to establish that the solid coffee products obtained as here disclosed provide excellent coffee beverages upon addition of boiling water, which beverages have a distinctly richer coffee taste, more natural, less bitter and fresh brewed-like coffee taste than the so-called instant or soluble coffees presently available commercially. To this effect, it has been found that the coffee product obtained by the process of the invention which provides an extruded product prepared from the green coffee extract and a matrix of coffe solids gave an excellent finished soluble coffee product.

The invention therefore also provides a far simpler and advantageous process for preparing soluble or instant coffee than those available heretofore. A process which further ensures minimal loss of the water soluble volatiles present in green coffee, since it dispenses with the evaporation steps which are required in prior art methods of preparing instant coffee. According to the preferred embodiment of the invention, the extraction with water is carried out under optimal conditions to preserve these volatiles and the heating step occurs in a closed environment (the extruder), thus further ensuring minimal loss of the volatile components that are essential to obtain a natural, freshly brewed coffee flavor.

### EXAMPLES

The invention is now described by way of the following examples but is not limited to these examples. Temperatures are given in degrees centigrade and abbreviations have the meaning common in the art.

### Example 1

General method for the preparation of a roasted coffee product

Extraction

In an Erlenmeyer ®, the ground coffee (from green coffee beans, grinded in an industrial grinder to provide particles having an average dimension of 0.5 to 0.7 mm) was suspended in the appropriate volume of water. The suspension, kept at the desired temperature by means of a bath, was stirred mechanically (˜600 to 900 rpm) during the selected time period. A small amount of Celite ® was then added to the suspension and the latter was filtered on a sintered glass funnel equipped with a bed of 3 cm of Celite ®. The filter was rinsed with water. The filtrate was frozen with liquid nitrogen and freeze-dried to provide an extract of green coffee according to the invention.

Roasting

A PYREX ® crystalizer (diameter 70 mm) was placed in a kitchen oven the temperature of which was controlled by a SYSTAG ® type system (origin: Systegra GmbH, Germany). Once the temperature had been adjusted and stabilized at the desired value, there was poured into the crystalizer the desired amount of freeze-dried green coffee extract (typically about 3 g) and the latter was allowed to roast for the appropriate amount of time. The crystalizer was then removed from the oven and allowed to cool down before scrapping the solid and grinding it finely for tasting and subsequent use. By following this method, roasted coffee products according to the invention were prepared in the following conditions:

Extraction

Weight of ground green coffee: 100 g

Extraction temperature: 20°

Water volume: 300 ml

Extraction time: 5 h

The suspension was filtered and rinsed with approximately 150 ml of water.

The filtrate was freeze-dried.

Roasting

3 g of the green coffee extract were heated to 190° C. (±0.7°) for 10 minutes. A dark brown roasted coffee product was thus obtained.

Coffee products according to the invention were thus prepared from three commercial origin qualities of ground green coffee beans, i.e. a mixture from several origins (Trottet, Geneva, Switzerland), a pure Arabica from Colombia (Collet, Annemasse, France) and a pure Robusta from the Ivory Coast (Collet, Annemasse, France). The amounts of solid coffee product after extraction and roasting were the following:

| Extract | Extraction | Roasting |
|---|---|---|
| MIXTURE | 22.5 g | 2.8 g |
| | | (yield 92%) |
| ARABICA | 23.0 g | 2.8 g |
| ROBUSTA | 23.4 g | 2.8 g |

The contents of the solid extracts of green coffee, before roasting, in chlorogenic acid were dosed by phase inverse high pressure liquid chromatography (HPLC) through their UV at 214 nm and under the following conditions:
Nucleosil C18-5 μm column, Macherey-Nagel, 250×4 mm i.d.;
HPLC Beckman 126 pumps;
Eluting agent: acetonitrile/water/trifluoroacetic acid 10/90/0.1%, at 1.2 ml/min;
Temperature: 25° C.;
Detection at 214 nm UV Beckman 168 diode detector, spectrum taken at UV spectre;
The pure chlorogenic acid was obtained from Fluka;
Calibration at 0.1, 0.033 and 0.025 mg/ml was carried out by means of a sample carrier Spark Holland Triathlon (dilutions from a mother solution at 1 mg/ml and injections of 20 μl);
Retention time for chlorogenic acid is 13.7 min.

Results

| | Chlorogenic acid |
|---|---|
| Extract | (% by weight) |
| MIXTURE | 13.0-15.3 |
| ARABICA | 12.3-13.0 |
| ROBUSTA | 14.6-14.8 |

### Example 2

Comparative test

A coffee extract was prepared following the prior art method described by De Maria et al. (reference cited), as follows:

75 g of ground green coffee (Trottet mixture, see Example 1) were added to 400 ml of hexane and the mixture was stirred for 20 h. After filtering on a sintered glass funnel, the filtrate was dried under vacuum. There were thus obtained 70.4 g of defatted green coffee (yield 94%) and 4.6 g of slightly yellow green oil.

50 g of this defatted coffee were suspended in 2000 ml of spring water heated to 80° C. and kept at this temperature and under stirring for 15 min. The suspension was filtered and the filtrate slightly concentrated under low vacuum, and the concentrate was frozen and freeze-dried. 13.1 g of green coffee extract were obtained (yield 26.3%). The content in chlorogenic acid of this extract was measured in a similar manner to that described in Example 1, and it was found to be 18.6 to 19% by weight. 3 g of this extract were roasted at 220° for 3 min to provide 2.6 g (yield 88%) of roasted extract (sample A, roasting according to De Maria et al.).

In parallel, the extract was roasted at 190° for 10 min to obtain a second roasted extract (sample B, roasting according to the present invention). These two samples were submitted for blind evaluation, together with the corresponding “MIXTURE” extract prepared according to Example 1 to a panel of expert flavorists. The latter tasted the extracts in hot water (>70°), at concentrations comprised between 0.5 and 2%.

In the flavorists opinion, the solution containing the “MIXTURE” product prepared as described in Example 1 possessed a very rich coffee flavor, with roast, pyrazine and caramel, sugar notes, typical of coffee taste.

The beverage of sample A was rejected by the flavorists who found its taste very poor, with very pronounced burnt, phenolic and caoutchouc notes.

As for the solution of sample B, it was found to be better, from an organoleptic point of view, than that of sample A, but distinctly worse than that of the “MIXTURE” extract above. Its taste was burnt, woody, slightly caramel, less natural and far more phenolic than that of the latter.

Moreover, a coffee extract was also prepared by extraction of ground green coffee (mixture Trottet) which had not been prior defatted, by using the same water/coffee ratio (2000 ml for 50 g of ground coffee), at 80°, for 15 min. The freeze-dried extract was then roasted at 190° for 10 min, and evaluated in conditions identical to those described here-above.

The result of this evaluation was that the taste of this extract was more phenolic, bitter and burnt than that of the extract obtained in Example 1. And this in spite of the fact that the roasting had been carried out in the same conditions.

### Example 3

Preparation of a roasted coffee product

A coffee extract was prepared from a mixture of green coffee of different origins (Trottet, Geneva, Switzerland), as follows:

A filtering phial, equipped with a sintered glass funnel of 10 cm of diameter, was charged with 50 g of mixture of ground green coffee and mineral water at room temperature (20-25° C.) was poured thereon. Slight stirring with a spatula and vacuum was applied by means of a water pump (˜4 min). Freeze-drying thus provided a first solid green coffee extract (3.9 g ; yield 7.7%).

200 ml of demineralised water, at the same temperature, were then poured on the already extracted 50 g of coffee, letting it gently run for about 5 min and rapidly concentrating under vacuum (˜12 min). A second solid extract was thus obtained (5.8 g ; yield 11.6%). A third extraction of this coffee with 200 ml of water, applying quick vacuum (˜15 min) and freeze-drying the solution, provided a third solid extract (1.6 g ; yield 3.2%).

All the extracts of green coffee thus obtained were then roasted at 190°, for 10 min, as described in Example 1.

These three roasted extracts, and their mixture, were blind evaluated by a panel of expert flavorists, in hot water, at a concentration of 0.5% by weight.

The result of this evaluation showed that the first extract possessed a taste of the roasted, cereal, woody, coffee type, the second extract possessed the good roasted notes typical of coffee and the third extract was characterized by a woody, roasted, coffee, slightly caramel, taste.

The mixture of these three extracts further possessed an organoleptic quality, similar to that of the “MIXTURE” prepared at Example 1.

### Example 4

Comparative test

Coffee extracts were prepared according to the extraction method described by De Maria et al. (reference cited), i.e. using a suspension of ground green coffee prior defatted, in a water volume of 40 ml per gram of ground coffee, at a temperature of 80°, for 15 min (see Example 2). The freeze-dried extracts were then roasted at 190° for 10 minutes. In this manner, there was prepared a coffee extract from pure Arabica green coffee (sample C) and a coffee extract from pure Robusta green coffee (sample D). These two samples were then evaluated on a blind test by flavorists, together with the “ARABICA” and “ROBUSTA” extracts obtained in Example 1, following the process of the invention.

In this evaluation, the extracts were tasted at a concentration of 2% by weight in very hot or boiling water (>70°). The result of this evaluation is summarized in the following table:

TABLE I

| Extract | Organoleptic description |
|---|---|
| C | Burnt, coffee brandy, smoked, slightly phenolic |
| D | Bitter, burnt, phenolic, coffee |
| ARABICA | Caramel, sugar, well roasted, coffee, sweet |
| ROBUSTA | Roasted, coffee, slightly fermented |

The flavorists indicated a clear preference for the “ARABICA” and “ROBUSTA” samples, the first having been judged the best, its taste and aroma being characteristic of the best quality freshly prepared coffees.

### Example 5

Preparation of roasted coffee products

Coffee extracts were prepared from pure Arabica green coffee from Colombia, using the general method and the conditions described in Example 1, except as regards the extraction temperature, which was varied as indicated in the following table:

TABLE II

| | Extraction temperature |
|---|---|
| Extract | (° C.) |
| ARABICA 1 | 3 |
| ARABICA | 20 |
| ARABICA 2 | 40 |
| ARABICA 3 | 60 |
| ARABICA 4 | 80 |
| ARABICA 5 | 100 |

The content in chlorogenic acid of the green coffee extracts, before roasting, was measured under the following conditions: HPLC Dosage, Nucleosil RP 18-5 μm, 250×4 mm i.d., acetonitrile/water 10%, 0.1% TFA, 1.2 ml/min, 25° C. Detection at 324 nm.

The table hereafter summarizes the results obtained, including for the extracts described in Example 4, table I, the extraction of which were carried out by the described prior art method.

TABLE III

| | Chlorogenic acid |
|---|---|
| Extract | (% by weight) |
| C | 15.3 |
| D | 17.2 |
| ARABICA | 11.6 |
| ROBUSTA | 12.2 |
| ARABICA 1 | 9.3 |
| ARABICA 2 | 12.1 |
| ARABICA 3 | 12.3 |
| ARABICA 4 | 12.8 |

The roasted extracts were then evaluated on a blind test by a panel of expert flavorists, at 2% by weight in hot water. The flavorists indicated a clear preference for the ARABICA 3 and ARABICA, followed by ARABICA 2. The description of the organoleptic properties of these roasted extracts resulting from this evaluation are presented the following table:

TABLE IV

| Extract | Organoleptic description |
|---|---|
| ARABICA 1 | Weak, caramel, burnt sugar |
| ARABICA | Coffee, roasted, slightly caramel |
| ARABICA 2 | Coffee, grilled, caramel, slightly bitter |
| ARABICA 3 | Good coffee note, slightly caramel |
| ARABICA 4 | Weak, sugar, burnt, caramel |
| ARABICA 5 | Week, slightly coffee and smoked |

### Example 6

Preparation of roasted coffee products

Coffee extracts were prepared from pure Arabica green coffee from Colombia, using the general method and the conditions described in Example 1, except as regards the volume of extraction water, which was varied as indicated in the following table:

TABLE V

| | Water volume |
|---|---|
| Extract | (ml per gram of ground coffee) |
| ARABICA | 3 |
| ARABICA 6 | 10 |
| ARABICA 7 | 20 |

These extracts were then evaluated on a blind test, at 2% by weight in hot water, by a panel of expert flavorists, which qualified their organoleptic properties as indicated hereafter:

TABLE VI

| Extract | Organoleptic description |
|---|---|
| ARABICA | see Tableau I |
| ARABICA 6 | Good roasted note of coffee, well rounded |
| ARABICA 7 | Coffee, well roasted |

### Example 7

Preparation of roasted coffee products

Roasted extracts of coffee prepared from a mixture of green coffee of different origins, following the extraction method and the conditions described in Example 1 and varying the roasting temperature between 160 and 250° C. and the roasting time between 1 and 40 minutes.

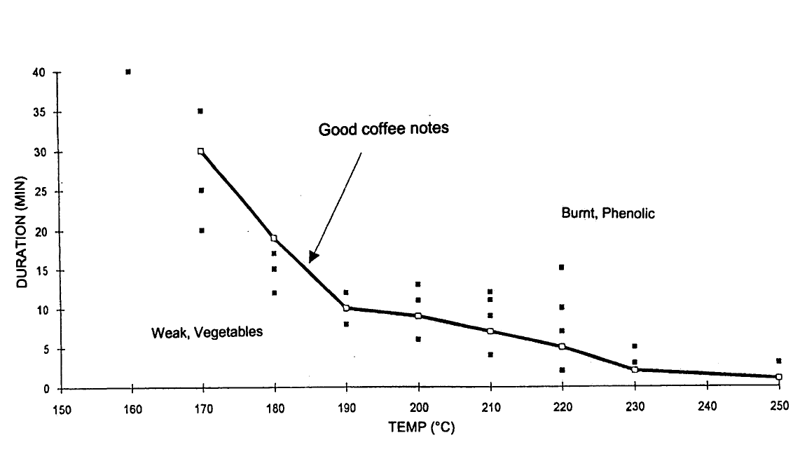

FIG. 1 summarizes the results of these tests. In this figure, the lign connecting the white squares indicates the best temperature/time combination for a given temperature, i.e. the combination which made it possible to obtain the best extract, from the organoleptic point of view, for this roasting temperature. The black squares represent other tests leading to less preferred extracts. On the other hand, as indicated in the figure, it was ascertained that the extracts roasted at temperatures above 200-210° were richer in burnt and phenolic notes, the latter becoming too pronounced and undesirable above 220°, whereas the extracts roasted at temperatures below 170-175° had weak and vegetable type tastes.

### Example 8

Preparation of roasted coffee extracts

Roasted extracts of coffee were prepared from pure Arabica green coffee, following the extraction method and the conditions described in Example 1, except for the extraction time which was varied as indicated hereafter:

TABLE VII

| | Extraction time |
|---|---|
| Extract | (h) |
| ARABICA 8 | 1 |
| ARABICA 9 | 3 |
| ARABICA | 5 |

These roasted extracts were then evaluated on a blind test, at 2% by weight in hot water, by a panel of expert flavorists, which qualified their organoleptic properties as indicated hereafter:

| Extract | Organoleptic description |
|---|---|
| ARABICA 8 | Good note of roasted coffee |
| ARABICA 9 | More roasted, coffee |
| ARABICA | See Table I |

The flavorists indicated a preference for the extract ARABICA 9, closely followed by the ARABICA.

### Example 9

Aromatisation of a soluble coffee

An instant soluble coffee of commercial origin was flavored by adding to the commercial coffee an ARABICA roasted extract as prepared in Example 1, in the concentrations indicated in the following table:

TABLE VIII

| | ARABICA EXTRACT |
|---|---|
| Sample of coffee | (% by weight) |
| 1 | 0 |
| 2 | 5 |
| 3 | 10 |
| 4 | 25 |
| 5 | 50 |

The 5 samples were then evaluated on a blind test by a panel of expert flavorists, in boiling water containing 1% by weight of coffee sample. The flavorists indicated a marked preference for the beverages prepared with samples 2 to 5, which they judged to have a more pronounced and rounded full-bodied roasted coffee character than that of sample 1.

### Example 10

Coffe beverage

A beverage coffee base was prepared with the following ingredients, used in the proportions indicated:

| Ingredients | Parts by weight |
|---|---|
| Sugar | 70 |
| Emulsifier (esters of sugar (p-1670) | 1 |
| Sodium bicarbonate | 0.3 |
| Milk | 250.0 |
| Soluble coffee of commercial origin | 20.0 |
| Water | q.s. |
| Total | 1000.0 |

The first three ingredients were completely dissolved in 100 parts by weight of the water, at 80°, by means of a mixer-homogenizer. The milk and coffee were then added and the volume completed to 1000 parts with the rest of the water. After having homogenized well in the mixer for 3 to 5 min, cans were filled with the beverage and tight sealed in a conventional manner.
The cans were then heated at 120° for 20 min, to sterilize their contents, and allowed to cool before tasting.
In addition, a novel beverage was also prepared as described here-above, by replacing the soluble coffee with a mixture thereof with ARABICA coffee extract (see Example 1) according to the invention, in a relative proportion soluble coffee/ARABICA of 9:1. The base beverage and this novel beverage were then evaluated on a blind test by a panel of expert flavorists. The latter indicated a unanimous preference for the novel beverage, which they judged to have a better coffee taste, the coffee note being more pronounced, roasted and rounded, being more full-bodied and having an enhanced bitter character typical of the strong coffee, without however possessing excessive bitterness.

### Example 11

Coffee tasting ice cream

An ice cream base was prepared as follows, with the ingredients indicated hereafter:

| Ingredients | Parts by weight |
|---|---|
| Cream (35% of fat matter) | 20 |
| Water | 51.5 |
| Powder skimmed milk | 10.5 |
| Sugar | 10.0 |
| Glucose syrup | 5.0 |
| Dextrose | 2.5 |
| Cremodan ® SE 30 ¹⁾ | 0.5 |
| Total | 100.0 |

¹⁾ origin Grinsted Products A/S, DK 8220 Braband, Danemark

The cream was admixed with the water and the milk under vigorous stirring at 20°, and then the mixture of sugar, dextrose and Cremodan ® was added at 40 C. The glucose syrup was added at 60° C. and the whole was well homogenized at 78° C. and 150 bar.
After pasteurising at 85° C. for 40 s, it was cooled to 4° C. and let to set at this temperature for 4 h. With this base mixture, and before freezing the mixture in the conventional manner in an ice cream making apparatus, an ice cream A was prepared by adding commercial soluble coffee to the base, at a concentration of 2% by weight, and an ice cream B was prepared by adding to the base 2% by weight of a 9:1 mixture of soluble coffee/ARABICA extract according to the invention (Example 1).
The two ice creams thus prepared were kept in the refrigerator for at least 2 days before being tasted.
Upon evaluation on a blind test by a panel of expert flavorists, it became apparent that all the flavorists preferred ice cream B. In their opinion, its coffee taste was far more pronounced than that of ice cream A, the coffee note being markedly richer and rounder, with a well roasted character and a bitterness characteristic of good strong coffees. This effect was particularly appreciated since it advantageously compensated the sweet, caramel, condensed milk type note of the ice cream base, unlike what was observed with ice cream A, the taste of which was more “white coffee” like.

### Example 12

Flavoring compositions

A flavoring base was prepared by admixing the following ingredients:

| Ingredients | Parts by weight |
|---|---|
| Sucrose | 567 |
| Glucose | 164 |
| Fructose | 110 |
| Arabinose | 74 |
| Arginine ^{*} | 23 |
| Cystine | 3 |
| Methionine | 4 |
| Serine | 17 |
| Threonine | 10 |
| Thiamine ^{*} | 28 |
| Total | 1000 |

* in the form of its hydrochloride

A flavoring composition according to the invention was prepared by adding to an extract of green coffee, obtained following the general extraction method previously described, namely in Example 1, the base composition above mentioned, in a concentration of 3.5% by weight, relative to the weight of the extract.
The new flavoring composition thus obtained was then roasted at around 190 to 200 C for 10 to 13 min and then tasted at 0.5% by weight in sweetened aqueous solution. Likewise, the green coffee extract was roasted and tasted in the same conditions.
In the opinion of the panel of flavorists who evaluated this novel flavoring composition on a blind test, comparing it to said coffee extract, the former had a very characteristic coffee taste, the grilled and roasted notes of which were even more pronounced than those of the roasted coffee extract which had not been added of the base composition
Similar tests were carried out with analogue base compoitions in which one had replaced for example arginine with a mixture of lysine and histidine, or into which these amino acids had been incorporated in addition to those mentioned above, or yet to which leucine or isoleucine had been added.
In all these tests, the amino acids were found to typically strengthen the grilled, roasted character of the roasted coffee extract used as the base element, thus rendering the taste of the latter even more natural and more typical of freshly brewed coffee.
Moreover, it was ascertained that the relative proportions of the amino acids cited above could be varied in a considerable range of values, without such variation having a significant effect on the organoleptic properties of the flavoring compositions thus obtained.
On the other hand, the mixture of sugars above-mentioned, i.e. sucrose, fructose, glucose and arabinose, could also be replaced by an equivalent amount of sucrose, thus providing, upon addition of the green coffee extract, a composition whose taste after roasting emulated in a remarkable manner that of freshly brewed coffee.

### Example 13

Preparation of an extruded coffee product

A dry blended formulation was prepared by admixing the following ingredients

| Ingredients | Weight in grams |
|---|---|
| Dried extract of green coffee ¹⁾ | 70 |
| Maltodextrin 18 DEf²⁾ | 425 |
| Lubricant ³⁾ | 5 |
| Total | 500 |

¹⁾ prepared according to Example 1
²⁾Morex ®; origin: Roquette
³⁾ 1:1 mixture of Citrem (citric acid ester); origin: Danisco and Neobee

The powder blend was extruded on Thermo Prism 16 mm eurolab extruder with 7 heating zones and through a 2 mm die. The screw configuration was made up of several mixing elements (preferably two). Water or propylene glycol was added as a plastifier in the appropriate amount to provide a product having a glass transition above 40° C. at constant sample composition. Processing temperatures were between 140 and 260° C., preferably 240° C. Pressure between 1 and 30 bar, preferably 10 bar. Throuput was from 250 g/h up to 3 kg/h.

1. A process for the preparation of an extract of green coffee, which comprises the following steps:
a) extracting with water, at a temperature below 70° C., ground coffee obtained from green coffee beans; and
b) removing the water from the thus obtained aqueous extract to form a solid extract of green coffee.

2. A process according to claim 1, wherein step a) is carried out at a temperature comprised between 15 and-25° C.

3. A process according to claim 1, wherein the extraction with water is carried out through stirring for at least 2 hours a suspension of grinded green coffee in water and subsequently filtering the resulting solution to collect the filtrate.

4. A process according to claim 3, wherein there is used a water volume comprised between 3 and 20 ml per gram of ground coffee.

5. A process according to claim 4, wherein the water extraction is carried out at 20° C. and by means of a water volume of 3 to 10 ml, said stirring being maintained for about 5 h.

6. A process according to claim 1, wherein the removal of water is carried out by freeze-drying.

7. An extract of green coffee susceptible of being obtained by the process according to claim 1.

8. An extract of green coffee according to claim 7, having a content in chlorogenic acid that does not exceed 15% by weight, relative to the weight of the extract.

9. An extract of green coffee according to claim 7, in the form of a composition further containing one or more compounds selected from the group consisting of sucrose, glucose, fructose and arabinose.

10. An extract of green coffee according to claim 7, in the form of a composition further containing one or more compounds selected from the group consisting of arginine, cysteine, leucine, isoleucine, serine, threonine, thiamine, lysine, histidine and their edible salts.

11. The composition of claim 9, which further comprises one or more compounds selected from the group consisting of arginine, cysteine, leucine, isoleucine, serine, threonine, thiamine, lysine, histidine and their edible salts.

12. A process for the preparation of a roasted coffee product, wherein an extract according to claim 7 is subjected to a thermal treatment carried out at an appropriate temperature and for a period of time sufficent to obtain a roasted coffee product.

13. A process according to claim 12, wherein the extract is roasted at a temperature comprised between 180 and 220° C., for a period of time comprised between 3 and 20 minutes and varying in an inverse proportion to the temperature.

14. A process according to claim 13, wherein the extract is roasted at a temperature of about 190° C. during approximately 10 minutes.

15. A process according to claim 12, wherein there is used an extract as cited in claim 11.

16. A roasted coffee product suscepbtible of being obtained by a process according to claim 12.

17. A process for the preparation of an extruded coffe product, which comprises:
a) combining and blending an extract according to claim 7 with an extrudable matrix material, an emulsifier and optionally a plasticizer, under temperature and pressure conditions useful to produce a uniform melt thereof;
b) extruding the molten mass through a die;
c) chopping, cutting, grinding or pulverizing the mass obtained either as it exits the die or after having cooled the molten mass; and
d) optionally drying.

18. A process according to claim 17, wherein the extrusion temperature is comprised between 90 and 130° and the molten uniform mixture is chopped as it exits the die to provide a product having a glass transition temperature Tg which is essentially the same as that of the matrix carrier material.

19. An extruded coffee product susceptible of being obtained by a process according to claim 17.

20. A method to impart, modify or enhance the coffee taste of a composition or of a consumer product, which comprises adding thereto a coffee product as in claim 16 in an amount sufficient to impart, modify or enhance the coffee taste of said composition or product.

21. A method according to claim 20, wherein said coffee product is added in an amount of 0.01 to 10% by weight, relative to the weight of composition or consumer product.

22. A flavored composition or consumer product resulting from the method of claim 20 and which is a food, a beverage, a chewing-gum, an oral care product or a pharmaceutical preparation.

23. A process for the preparation of a solid coffee product, which comprises the following steps:
a) the extraction with water, at a temperature below 70° C., of ground coffee obtained from green coffee beans;
b) the removal of the water from the thus obtained aqueous extract to form a solid extract of green coffee;
c) the thermal treatment of said solid extract of green coffee, carried out at an appropriate temperature and for a period of time sufficent to obtain a solid coffee product.
